(19) United States
(12) Patent Application Publication
(10) Pub. No.: US 2005/0010561 A1
(43) Pub. Date: Jan. 13, 2005

(54) System for generating queries

(75) Inventors: Luc de Bois, Courbevoie (FR); Guillaume Allys, Paris (FR); Stephane Martin, Paris (FR); Dominique Kirsner, Nogent Sur Marne (FR)

Correspondence Address: James R. Williams;Jameson, Seltzer, Harper & Williams, 2625 Wilmington Road, New Castle, PA, 16105, US

(73) Assignee: France Telecom, Paris (FR)

(21) Appl. No.: 10/832,821

(22) Filed: Apr. 27, 2004

(30) Foreign Application Priority Data
Apr. 28, 2003 (FR) 0305189

(51) Int. Cl. G06F 17/30

(52) U.S. Cl. 707/3

(57) ABSTRACT

This system for assisting generating queries comprises means for generating a query using logic operators to link selected concepts. The generation means comprise means for determining logic operators of the query on the basis of the nature of predetermined semantic links between the selected concepts.

The present invention relates to a system for assisting generating queries, the system comprising means for generating a query using logic operators to link selected concepts. The invention also relates to a method used by the system.

### BACKGROUND OF THE INVENTION

The queries generated are generally intended to be used by a search engine to supply pertinent documents in response to the queries.

Different types of systems for assisting generating queries are known in the art. In particular, systems for assisting generating queries in natural language are known in the art, but give rise to problems linked to the ambiguities of declarations made by users when defining queries in natural language. It is often necessary to ask the user to explain a query to resolve such ambiguities.

Systems for assisting generating queries that present a user with predefined headings and guide the user through the headings in order to specify the query are also known in the art. Such systems are too limited because of the a priori definition of headings and are not appropriate for generalized use.

Finally, systems for assisting generating Boolean queries, i.e. queries using Boolean operators to combine keywords or concepts, are also known in the art. Those systems require the user to construct a query in a logical manner, which is not easy, especially if the query encompasses a number of concepts. Moreover, a small error perpetrated by the user in certain Boolean combinations of concepts can generate a query that no longer reflects user requirements in any way.

### OBJECTS AND SUMMARY OF THE INVENTION

The invention aims to remedy these drawbacks by providing a system for assisting generating queries that is capable of generating queries, and in particular Boolean queries, without requiring the user to make excessive abstraction efforts to combine in a logical manner the concepts of the query so that the query does indeed reflect the user's requirements.

The invention therefore consists of a system for assisting generating queries, the system comprising means for generating a query using logic operators to link selected concepts, and wherein the generation means comprise means for determining logic operators of the query on the basis of the nature of predetermined semantic links between the selected concepts and means for formatting the query by combining concepts with the aid of the determined logic operators.

Accordingly, since the user selects a certain number of concepts and the system determines the logical combination linking those concepts by itself, based on the nature of the semantic links that link the selected concepts, the abstraction effort is supplied by the system itself, not by the user.

A system according to the invention for assisting generating queries may further present one or more of the following features:
it includes storage means for storing a semantic network of concepts and means for selecting a given concept and concepts linked semantically to said given concept directly or indirectly on the basis of concepts contained in the storage means;
it includes means for selecting a set of concepts linked semantically to said given concept directly or indirectly by links of the same kind and of a predetermined type specific to said set;
it includes means for modifying and updating the semantic network; and
the nature of the predetermined semantic links between selected concepts is one of the elements of the set comprising referent links for synonymous concepts, semantic extension links, and crossover axis links of the query.

The invention also provides a method for assisting generating queries, the method comprising a step of generating a query using logic operators to link selected concepts, and the method including a step of determining logic operators of the query on the basis of the nature of predetermined semantic links between the selected concepts and a step of formatting the query by combining the concepts with the aid of the determined logic operators.

A method according to the invention for assisting generating queries may further include the feature whereby the nature of the predetermined semantic links between the selected concepts is one element from the set comprising referent links for synonymous concepts, semantic extension links, and crossover axis links of the query, and a Boolean “AND” operator is applied to two concepts linked by a crossover axis link, and a Boolean “OR” operator is applied to two concepts linked by a referent link or a semantic extension link.

### BRIEF DESCRIPTION OF THE DRAWINGS

The invention will be better understood in the light of the following description, which is given by way of example only and with reference to the appended drawings, in which:

FIG. 1 represents the general structure of a system of the invention for assisting generating queries, and

FIG. 2 represents an interface for the system of FIG. 1.

### MORE DETAILED DESCRIPTION

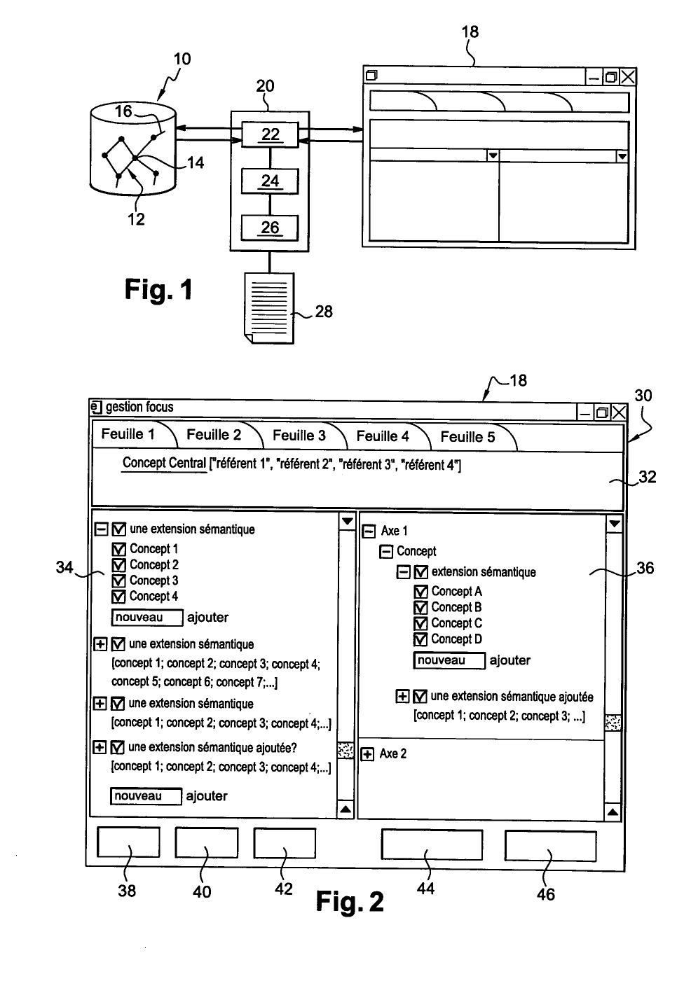

The system shown in FIG. 1 comprises a knowledge base 10 for storing a semantic network 12 comprising nodes 14 and semantic links 16 between the nodes. Each node 14 of the semantic network 12 represents a concept. A concept is a group of words, for example, or more specifically a predetermined keyword.

Each concept 14 is linked to other concepts of the semantic network 12 by semantic links 16 that are of different kinds, as a function of the specific relations between two particular concepts.

In a preferred embodiment, the links available to link a given concept 14 to other concepts of the semantic network 12 are of three different kinds:
referent links that link the given concept 14 to other concepts of the semantic network that represent terms that are synonyms of the term designating the given concept 14;
semantic extension links that link the given concept 14 to other concepts of the semantic network that have a more remote relationship to the given concept; and
crossover axis links that link the given concept 14 to other concepts of the semantic network liable to throw a particular light on the given concept.

It will be noted that concepts linked to the given concept 14 by semantic extension links may be grouped into subsets as a function of particular types of semantic extension link. For example, if the given concept 14 represents a business, a particular “Subsidiaries” type of semantic extension link may be used to link concepts representing subsidiaries of the business to the given concept 14, while another particular “Managers” type of semantic extension link may be used to link concepts representing the managers of the business to the given concept 14.

Similarly, concepts linked to the given concept 14 by crossover axis links may be grouped into subsets as a function of particular types of crossover axis link, defined as a function of the particular light that the concepts throw on the given concept 14.

An example of a given concept 14 and of concepts linked to that given concept by referent links, semantic extension links, and crossover axis links of different types is set out below (the concepts themselves are shown in boldface type):
Central concept France Telecom
   Referent links:
      Concept 1 FTE
      Concept 2 FT
   Managers semantic extension links
      Concept 1 Michel Bon
      Concept 2 Thierry Breton
   Subsidiaries semantic extension links
      Concept 1 Orange
      Concept 2 Equant
   Rating watch crossover axis links
      Concept 1 Rating agency
         Main agencies semantic extension links
         Concept 1 Moody's
         Concept 2 S&P
         Title of analysts semantic extension links
         Concept 1 Market strategist
         Concept 2 Economist
      Concept 2 Ratings
         Short-term notes semantic extension links
         Concept 1 A
         Concept 2 B
         Long-term notes semantic extension links
         Concept 1 AAA
         Concept 2 AA
   Takeover bid watch crossover axis links
      Concept 1 Takeover bid
         Takeover bid rumor semantic extension links
         Concept 1 Action suspended
         Concept 2 Communique
         Current takeover bid semantic extension links
         Concept 1 Merge
         Concept 2 Make an offer
      Concept 2 Supervisory authority
         France semantic extension links
         Concept 1 COB
         Concept 2 CMF
         Europe semantic extension links
         Concept 1 Antitrust
         Concept 2 European comm.

The system for assisting generating queries further includes means 20 for generating a Boolean query comprising a number of concepts selected in the knowledge base 10. The Boolean query generating means 20 are connected to the knowledge base 10 in read mode and in write mode for selecting concepts 14 or modifying and updating the semantic network 12 and are also connected in read mode and in write mode to an information query definition interface 18 described in detail with reference to FIG. 2.

The Boolean query generation means 20 comprise first means 22 for selecting chosen concepts in the knowledge base 10 by means of the interface 18. The selection means 22 are connected to means 24 for determining Boolean operators for a query on the basis of the concepts that constitute it.

The means 24 determine the Boolean operators as a function of the nature of the semantic links between the selected concepts in the query.

Accordingly, if two concepts in the semantic network 12 are linked by a referent link or a semantic extension link, the determination means 24 apply a Boolean “OR” operator to the concepts in the query. If two concepts in the semantic network 12 are linked by a crossover axis link, the determination means 14 apply a Boolean “AND” operator to the two concepts in the query.

The determination means 24 are themselves connected to means 26 for formatting and where applicable transmitting the final query 28 obtained by the Boolean combination of the selected concepts. The means 26 are adapted to take up the concepts selected by the selection means 22 and to combine them with the aid of the operators determined by the means 24. Note that in the final query 28 each concept may be associated with a weighting coefficient for refining the query.

Thus, for example, if the selected concepts are those cited in the above example, the final query 28 may take the following formalized form:

| France Telecom × coef1 | |
|---|---|
| OR | ( FTE × coef2 OR FT × coef3) |
| OR | ( Michel Bon × coef4 OR Thierry Breton × |
| coef5) | |
| OR | ( Orange × coef6 OR Equant × coef7) |
| AND | ( |
| | Rating agency × coef8 |
| | OR (Moody's × coef9 OR S&P × coef10) |
| | OR (Market strategist × coef11 OR |
| | Economist × coef12) |
| | OR |
| | Ratings × coef13 |
| | OR (A × coef14 OR B × coef15) |
| | OR (AAA × coef16 OR AA × coef17) |
| | ) |
| AND | ( |

```
  Takeover bid × coef 18
    OR (Action suspended × coef19 OR
        Communiqué × coef20)
    OR (Merger × coef21 OR Make an offer ×
        coef22)
  OR
  Supervisory authority × coef23
    OR (COB × coef24 OR CMF × coef25)
    OR (Antitrust × coef26 OR
        European Comm. × coef27)
)
```

As shown in FIG. 2, the interface 18 for assisting generating queries comprises a dialog box for presenting concepts. This dialog box has a first area 30 at the top in the form of a horizontal stripe within which are represented tabs labeled “Sheet 1”, “Sheet 2”, etc.

Each tab corresponds to a specific query, the interface 18 managing a plurality of queries simultaneously.

If a tab is selected, for example the tab “Sheet 2”, the elements available for constituting the corresponding query are displayed in respective corresponding areas 32, 34 and 36 below the tabs area 30.

The first of these areas is an area 32 for presenting a central concept of the query and concepts in the semantic network 12 linked to that central concept by a referent link.

The second of these areas is an area 34 for presenting concepts from the semantic network 12 linked to the central concept by a semantic extension link. In this second area 34, the concepts may be organized and grouped as a function of the type of semantic extension link that links them to the central concept.

The third of these areas is an area 36 for presenting concepts linked to the central concept in the semantic network 12 by a crossover axis link. Once again, these concepts may be organized and grouped as a function of the type of crossover axis link that links them to the central concept.

Dedicated icons are used for each of the concepts or for each of the groups of concepts presented by the interface 18 to obtain further information or to select them individually or in groups, for example by type of links.

In the conventional way, the interface 18 also enables the user to insert new concepts linked to one of the presented concepts by one of the available types of link (referent link, semantic extension link or crossover axis link), which allows for modification of the semantic network 12 stored in the knowledge base.

Icons in the lower portion of the dialog box are used to execute general functions such as:
renaming a tab (icon 38);
deleting a query by deleting the corresponding tab (icon 40);
storing changes made to the activated query (icon 42);
closing the dialog box and saving the changes (icon 44); and
closing the dialog box without saving the changes (icon 46).

It will be noted that the concepts presented in one of the areas 32, 34 or 36 are themselves linked to other concepts of the semantic network 12 by referent links, semantic extension links or crossover axis links. Accordingly, in a preferred embodiment of the invention, the dialogue box is used to display recursively concepts linked to concepts already displayed, for example in a tree structure, for visualizing and generating a query comprising multiple concept levels.

It is clear that a system according to the invention for assisting generating queries provides an easy way of generating Boolean queries that is transparent for the user.

1-7. (canceled)

8. A system for assisting generating queries, the system comprising a generator for a query using logic operators to link selected concepts, wherein the generator comprises a determinator for logic operators of the query based on predetermined semantic links between the selected concepts and a formatter for the query which combines concepts using the determined logic operators.

9. The system of claim 8, the system including storage for a semantic network of concepts and a selector for a given concept and concepts linked semantically to the given concept based on concepts contained in storage.

10. The system of claim 9, the system including a set selector for selecting a set of concepts linked semantically to the given concept by links of the same kind and of a predetermined type specific to the set.

11. The system of claim 9, the system including a device for modifying and updating the semantic network.

12. The system of claim 8, wherein the predetermined semantic links between selected concepts is an element of a set comprising referent links for synonymous concepts, semantic extension links, and crossover axis links of the query.

13. A method for assisting generating queries, the method comprising:
a) generating a query using logic operators to link selected concepts;
b) determining logic operators of the query based on predetermined semantic links between the selected concepts; and
c) formatting the query by combining the selected concepts using the determined logic operators.

14. The method of claim 13, wherein the predetermined semantic links between the selected concepts is an element of a set comprising referent links for synonymous concepts, semantic extension links, and crossover axis links of the query, and a Boolean “AND” operator is applied to two concepts linked by a crossover axis link, and a Boolean “OR” operator is applied to two concepts selected from the group consisting of a referent link or a semantic extension link.

15. A system for assisting generating queries, the system comprising means for generating a query using logic operators to link selected concepts, wherein the generation means comprise means for determining logic operators of the query based on predetermined semantic links between the selected concepts and means for formatting the query by combining concepts using the determined logic operators.
